(19) United States
(12) Patent Application Publication
(10) Pub. No.: US 2006/0277577 A1
(43) Pub. Date: Dec. 7, 2006

(54) Terminal, method and computer program product for performing operations with respect to broadcast content

(75) Inventors: Arto Kiiskinen, Espoo (FI); Ari Aarnio, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/262,538

(22) Filed: Oct. 28, 2005

Related U.S. Application Data
(63) Continuation-in-part of application No. 11/146,876, filed on Jun. 7, 2005.

(51) Int. Cl. H04N 7/173; H04N 7/16

(52) U.S. Cl. 725/62; 725/100

(57) ABSTRACT

A mobile terminal for performing operations with respect to broadcast content includes a controller capable of operating a client application. The client application can perform operations including operating in a recording mode. In the recording mode, the client application can record content for a selected channel, and store the recorded channel in a database. In response to changing channels from the selected channel to another channel, the client application can initiate a recording timeout for the selected channel. The client application can reset the recording timeout for the selected channel for each subsequent instance of changing channels back to the selected channel. If the recording timeout expires before being reset for a subsequent instance of changing channels back to the selected channel, however, the client application can cease recording content for the selected channel.

### CROSS-REFERENCE TO RELATED APPLICATIONS

The present application is a continuation-in-part of U.S. patent application Ser. No. 11/146,876, entitled: System and Associated Terminal, Method and Computer Program Product for Directional Channel Browsing of Broadcast Content, filed Jun. 7, 2005, the contents of which are incorporated herein by reference in its entirety.

### FIELD OF THE INVENTION

The present invention generally relates to systems and methods for providing broadcast content and, more particularly, to terminals, methods and computer program products for performing operations with respect to broadcast content.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. In this regard, the increased bit rates of 3G systems widen the possibilities for providing digital services.

The increased bit rates of 3G systems provide adequate performance for delivering high quality digital audio and acceptable quality moving image clips or videos as an example of from point-to-point data delivery mechanisms. One such delivery technique that has shown promise is Digital Video Broadcasting (DVB). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently and simultaneously transmitting large amounts of data over a broadcast channel to a high number of users. DVB-H (handheld), which is also related to DVB-T, can provide such increased performance particularly for wireless data delivery to handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), Digital Multimedia Broadcasting (DMB) and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and relatively very low cost digital broadband delivery techniques provides the possibility of interactive services such as unidirectional and bi-directional services such as audio and video streaming (e.g., TV, radio, etc.), file downloads and advanced gaming applications, etc.

It is contemplated that digital broadband data broadcast networks will be used to broadcast content for one or more television, radio and/or data channels. For example, it is contemplated that mobile television DVB-H broadcasts will include content for 10-50 or more television channels. In various instances, such content is broadcast in bursts each of which includes time-sliced content for a plurality of channels. This broadcasting of channels in time slices achieves power saving in mobile devices by permitting such devices to power up to receive a burst of time-sliced content for a number of channels, and then power down for the longer time period between bursts.

As will be appreciated, when a plurality of available channels of content are broadcast, the user may desire to browse through the available channels to select a desired channel to receive and consume (e.g., display, play, etc.). Such browsing, often referred to as “channel hopping,” generally includes the user moving from one channel to the next one by one, selecting each channel so that the user briefly receives content for the selected channel until the moving on to the next channel. By briefly receiving content for a selected channel, the user can assess the received content, and decide to either continue to receive that content (ceasing to channel hop), or move on to the next channel.

As will also be appreciated, because channels may be broadcast in bursts that include time-sliced content for those channels, users moving from one channel to the next may experience a time delay (i.e., channel tuning time) dependent upon the burst interval as well as a number of other delays. Undesirably, such time delays can last up to ten seconds or more. To decrease this time delay, however, techniques have been developed to buffer content for channels on either side of the currently selected channel into memory of the user device. In accordance with such techniques, then, users receive content for three channels, as opposed to one channel, with one channel of content being consumed and the other two being buffered in memory. Thus, if the user moves on to the next channel, that channel's content can initially be pulled from the buffer memory to avoid the time delay of waiting until the next burst interval to receive its content. But while such buffering may reduce the delay associated with channel hopping from one channel to the next, it also reduces the power saving benefits of broadcasting channels in time-sliced bursts, and may not even be possible to fully achieve with current receiver performance. Further, such conventional techniques may require users to choose between consuming content for a channel and channel hopping other channels, thereby requiring a user to forego consumption of content for a channel should the user choose to channel hop.

### SUMMARY OF THE INVENTION

In light of the foregoing background, exemplary embodiments of the present invention provide an improved terminal, method and computer program product for directional channel browsing of broadcast content for a plurality of channels of broadcast content, and recording content for one or more channels during such channel browsing. During channel browsing, exemplary embodiments of the present invention controllably buffer content for one or more channels of content in a manner that decreases the delay associated with channel hopping without incurring the reduction in power saving experienced in buffering channels on either side of a selected channel. In this regard, the terminal of exemplary embodiments of the present invention includes a buffer memory that may remain empty while the terminal receives and consumes content for a selected channel, where the selected channel is one of a plurality of ordered channels. During such consumption, the terminal may be directed to begin recording content for the selected channel.

When the terminal user selects a channel adjacent the selected channel, thereby initiating a channel hopping sequence, the terminal begins to buffer content for one or more next adjacent channels in the same direction from the selected channel. Exemplary embodiments of the present invention are therefore capable of at least partially buffering channels of content during channel hopping, without requiring the terminal to continuously buffer channels on either side of a selected channel. Then, when the terminal user ends the channel hopping sequence, the terminal can clear the buffer and operate without it until the terminal user again begins to channel hop. In addition, the terminal can cease recording content for a previously selected channel. If the user returns to the previously selected channel during the channel hopping sequence, or at the conclusion of the sequence, the terminal may continue to record content for that channel. The terminal can be directed to consume content for the recorded channel as the terminal receives content for that channel, and subsequently consume the recorded content for that channel. By way of example, the terminal may be directed to consume currently broadcast content before consuming the previously broadcast and recorded content. Additionally or alternatively, the terminal can be directed to first consume recorded (or further recorded) content for the channel, while the terminal continues to record content for that channel as the terminal receives such content. In such instances, the terminal can consume broadcast content for the channel received while the terminal user channel hopped to other channels and after the terminal user returned to the channel in a sequential manner. Thus, exemplary embodiments of the present invention are also capable of achieving the full benefits of power saving resulting from delivering content in time-sliced bursts while the terminal user is not channel hopping.

According to one aspect of the present invention, a mobile terminal is provided for recording broadcast content. The terminal includes a database capable of storing content, and a controller capable of operating a client application. The client application is capable of performing one or more operations with respect to a selected channel x of a set of channels of broadcast content. The operations capable of being performed by the client application include (a) operating in a recording mode with respect to currently broadcast content for the selected channel, (b) operating in a recording mode with respect to scheduled content for the selected channel, and/or (c) operating in an alert mode with respect to scheduled content for the selected channel. When operating in the recording mode, the client application is capable of recording the content for the selected channel and storing the recorded content in a database. Then, in response to changing channels from the selected channel to another channel in the set of ordered channels, the client application is capable of initiating a recording timeout for the selected channel. In this regard, the client application is capable of resetting the recording timeout for the selected channel for each subsequent instance of changing channels back to the selected channel. If the recording timeout expires before being reset for a subsequent instance of changing channels back to the selected channel, however, the client application is capable of ceasing recordation of content for the selected channel. When the channel is changed back to the selected channel, however, the client application can be further capable of consuming the recorded content for the selected channel, and thereafter receiving and consuming content for the selected channel.

More particularly, the client application can be capable of changing channels from the selected channel x to an adjacent channel x±1 in the set of ordered channels, thereby changing the channel in a given direction from the selected channel x. Further in response to changing channels to the adjacent channel x±1, then, the client application can be capable of receiving and storing content for Y next adjacent channels (x±1)±y, y=1, . . . , Y in buffer memory. In this regard, content for the next adjacent channels can be received and stored based upon the direction in which the channel is changed and in response to changing channels to the adjacent channel. Thus, if the channel is changed from the adjacent channel x±1 to a channel other than the next adjacent channel (x±1)±y, the client application can be further capable of receiving and consuming content for the channel other than the next adjacent channel independent of the stored content.

The client application can be capable of operating at one or more instances to receive and consume content for the selected channel x, change channels from the selected channel x to the adjacent channel x±1, receive and consume content for the adjacent channel x±1, and receive and store content for the next adjacent channels (x±1)±y. In such instances where the client application operates in a plurality of such instances, then, the adjacent channel x±1 of one instance becomes the selected channel x for a next instance such that x=x±1 from one instance to the next. Also in such instances, the client application can be further capable of initiating a buffer timeout after changing channels from the selected channel x to the adjacent channel x±1, where initiating the buffer timeout includes resetting the buffer timeout for each subsequent instance of changing channels. Accordingly, the client application can be capable of ceasing receipt and storage of content for Y next adjacent channels (x±1)±y, y=1, . . . , Y in buffer memory if the buffer timeout expires before being reset for a subsequent instance of changing channels. Also in such instances, the client application can be further capable of clearing the buffer memory.

According to other aspects of the present invention, a method and computer program product are provided for recording broadcast content. Therefore, exemplary embodiments of the present invention provide an improved terminal, method and computer program product for recording broadcast content. In this regard, the terminal of exemplary embodiments of the present invention is capable of channel browsing or hopping a plurality of channels of broadcast content, and recording content for one or more channels during such channel browsing, where recording content can cease upon settling on a channel other than respective channels being recorded. Also during such channel browsing, exemplary embodiments of the present invention are capable of controllably buffering content for one or more channels of content during channel hopping based upon a direction the channels are being changed. Then, after completion of the channel hopping sequence, indicated by expiration of the buffer timeout, the terminal is capable of ceasing buffering of content and, if so desired, clearing the buffer. Therefore, the terminal, method and computer program product of exemplary embodiments of the present invention may solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one exemplary embodiment of the present invention including a cellular network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with exemplary embodiments of the present invention;

FIG. 3 is a functional block diagram of a digital broadcast receiving terminal, in accordance with one exemplary embodiment of the present invention;

FIG. 4 is a functional block diagram of the digital broadcaster, in accordance with one exemplary embodiment of the present invention;

FIG. 5 is a schematic illustration of ordered channels of broadcast content, in accordance with one exemplary embodiment of the present invention;

FIG. 6 is a schematic block diagram of a mobile station that may operate as a terminal, according to exemplary embodiments of the present invention;

FIG. 7 is a functional block diagram of a terminal receiving broadcast content for one or more channels of a set of ordered channels, in accordance with exemplary embodiments of the present invention;

FIGS. 8a, 8b and 8c are flowcharts of various steps in a method of recording broadcast content, in accordance with exemplary embodiments of the present invention;

FIG. 9 is a flowchart illustrating various steps in a method of presenting displays of a terminal, and receiving selections of options presented thereby, in accordance with exemplary embodiments of the present invention;

FIGS. 10a and 10b are schematic illustrations of displays capable of being presented during operation of a terminal in accordance with exemplary embodiments of the present invention;

FIGS. 11a-11f are schematic illustrations of ordered channels of content during operation of a terminal in accordance with one exemplary embodiment of the present invention;

FIGS. 12a-12h are schematic illustrations of ordered channels of content during operation of a terminal accounting for channel subscriptions in buffering channels, in accordance with another exemplary embodiment of the present invention; and

FIGS. 13a-13c are schematic illustrations of a set of ordered channels of broadcast content, where the set defined by a content source (FIG. 13a) is altered as to the channels included in the set (FIG. 13b), and the ordering of the channels included in the set (FIG. 13c).

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

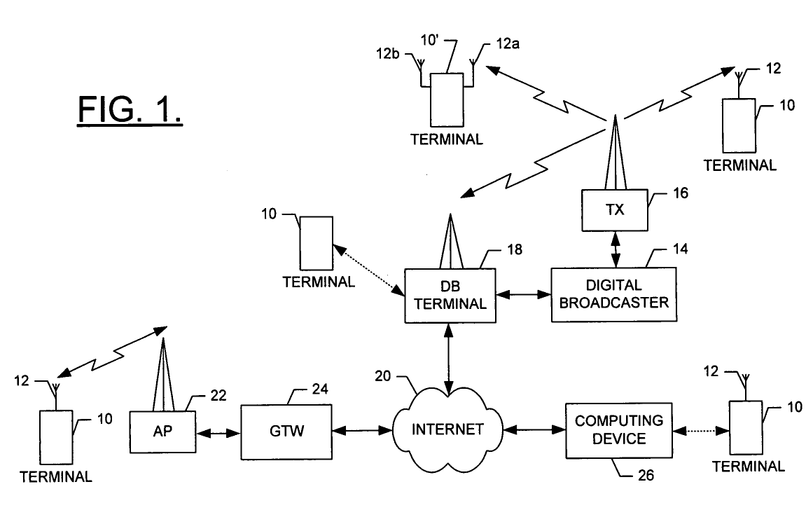

Referring to FIG. 1, an illustration of one type of terminal and system that would benefit from the present invention is provided. As shown, a terminal 10 may include an antenna 12 for transmitting signals to and for receiving signals from a digital broadcaster 14 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 16, such as a DVB TX. Similarly, the terminal can include a receiver, such as a DVB-H receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique. In such an embodiment, the terminal 10′ may include an antenna 12a for receiving content from the DVB TX, and another antenna 12b for transmitting signals to and for receiving signals from a base site or base station (BS) of a cellular network (not shown). For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 14 via the TX 16, the terminal can be coupled to a digital broadcast (DB) receiving terminal 18 which, in turn, can be coupled to the digital broadcaster, such as directly and/or via the TX. In such instances, the digital broadcast receiving terminal can comprise a DVB receiver, such as a DVB receiver in the form of a set top box. The terminal can be locally coupled to the digital broadcast receiving terminal, such as via a personal area network. In one exemplary embodiment, however, the terminal can additionally or alternatively be indirectly coupled to the digital broadcast receiving terminal via a data network, such as a local area network (LAN), a metropolitan area network (MAN), and/or a wide area network (WAN) like the Internet 20. The terminal can be directly coupled to the Internet, or indirectly coupled to the Internet. For example, the terminal can be coupled to the Internet, and thus the digital broadcast receiving terminal, via a wireless access point (AP) 22 and/or a gateway (GTW) 24. Additionally or alternatively, for example, the terminal can be coupled to the Internet via one or more other computing devices 26, such as personal computers, server computers or the like.

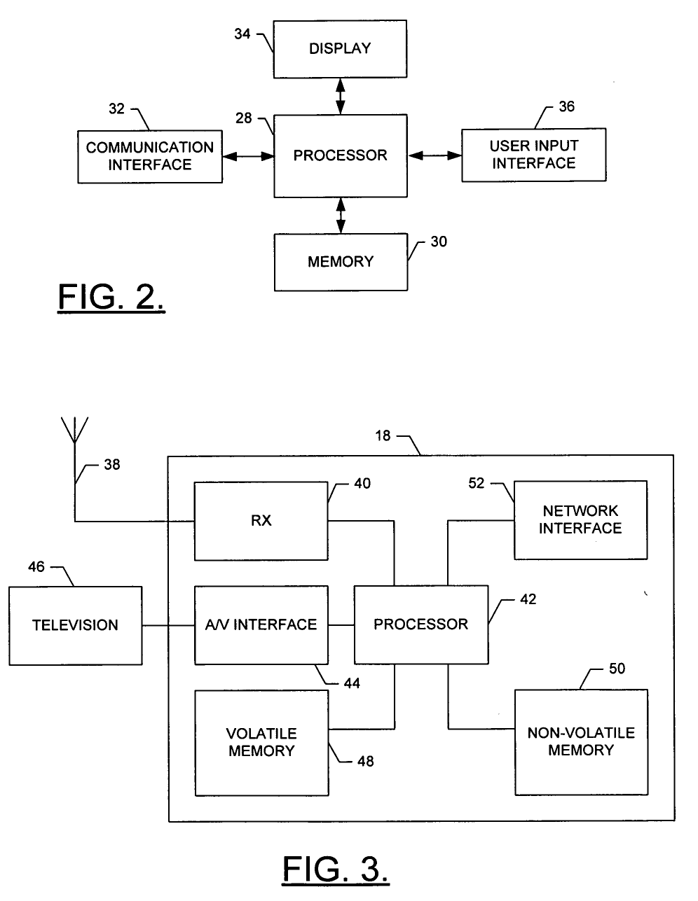

Referring now to FIG. 2, a block diagram of an entity capable of operating as a terminal 10, digital broadcaster 14 and/or digital broadcast receiving terminal 18 is shown in accordance with one embodiment of the present invention. Although shown as separate entities, in some embodiments, one or more entities may support one or more of a terminal, digital broadcaster and/or digital broadcast receiving terminal, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

The entity capable of operating as a terminal 10, digital broadcaster 14 and/or digital broadcast receiving terminal 18 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 28 connected to a memory 30. The memory can comprise volatile and/or non-volatile memory, and stores content, data or the like. For example, the memory stores content transmitted from, and/or received by, the entity. Also for example, the memory stores client applications, instructions or the like for the processor to perform steps associated with operation of the entity in accordance with exemplary embodiments of the present invention. As explained below, for example, the memory can store client application(s), such as a conventional text viewer, audio player, video player, multimedia viewer or the like, for consuming content for one or more television, radio and/or data channels.

Also, for example, the memory 30 can store a digital rights management (DRM) engine integral or otherwise in communication with one or more client application(s) such that the DRM engine can control the consumption of content based upon a DRM technique. Such a DRM engine may be configured in accordance with any of a number of different DRM techniques including, for example, that defined by the Open Mobile Alliance (OMA) Digital Rights Management specification. Further, the memory can store a decryption module integral or otherwise in communication with one or more client application(s) and the DRM engine such that the encryption/decryption module can encrypt content for consumption by the client application(s). In this regard, the decryption module can be configured to decrypt content in accordance with any of a number of different techniques by which the content is encrypted including, for example, Internet Protocol Security (IPSec), Secure Real Time Transport Protocol (SRTP) or the like.

As described herein, the client application(s), DRM engine and decryption module each comprise software operated by the respective entities. It should be understood, however, that any one or more of the client applications, DRM engine and decryption module described herein can alternatively comprise firmware or hardware, without departing from the spirit and scope of the present invention. Generally, then, the terminal 10, digital broadcaster 14 and/or digital broadcast receiving terminal 18 can include one or more logic elements for performing various functions of one or more client application(s), DRM engine and/or decryption module. As will be appreciated, the logic elements can be embodied in any of a number of different manners. In this regard, the logic elements performing the functions of one or more client applications, DRM engine and/or decryption module can be embodied in an integrated circuit assembly including one or more integrated circuits integral or otherwise in communication with a respective network entity (i.e., terminal, origin server, digital broadcast receiving terminal, digital broadcaster, etc.) or more particularly, for example, a processor 28 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 30, the processor 28 can also be connected to at least one interface or other means for displaying, transmitting and/or receiving data, content or the like. In this regard, the interface(s) can include at least one communication interface 32 or other means for transmitting and/or receiving data, content or the like, as well as at least one user interface that can include a display 34 and/or a user input interface 36. The user input interface, in turn, can comprise any of a number of devices allowing the entity to receive data from a user, such as a keypad, a touch display, a joystick or other input device. As more particularly explained below, for example, the user input interface can include one or more directional keys (hard and/or soft keys) for directionally selecting ordered items, such as ordered channels of content.

Reference is now made to FIG. 3, which illustrates a functional block diagram of a digital broadcast receiving terminal 18, in accordance with one embodiment of the present invention. As shown, the digital broadcast receiving terminal includes an antenna 38 for receiving signals from a digital broadcaster 14 and feeding the signals into a receiver (RX) 40. In turn, the receiver is capable of decrypting, demodulating and/or demultiplexing the signals, such as to extract content data. The receiver can feed the content data to a processor 42, which can thereafter decode the content data. The processor can then feed the decoded signal into an audio/video (A/V) interface 44, which can convert signals to a form suitable for display by a monitor, such as a television set 46.

The digital broadcast receiving terminal 18 can include volatile memory 48, such as volatile Random Access Memory (RAM) including a cache area for the temporary storage of data. The digital broadcast receiving terminal can also include non-volatile memory 50, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 14.

The digital broadcast receiving terminal 18 can also include one or more interface means for sharing and/or obtaining data from electronic devices, such as terminals 10 and/or digital broadcasters 14. More particularly, the digital broadcast receiving terminal can include a network interface means 52, for sharing and/or obtaining data from a network, such as the Internet 20. For example, the digital broadcast receiving terminal can include an Ethernet Personal Computer Memory Card International Association (PCMCIA) card configured to transmit and/or receive data to and from a network, such as the Internet.

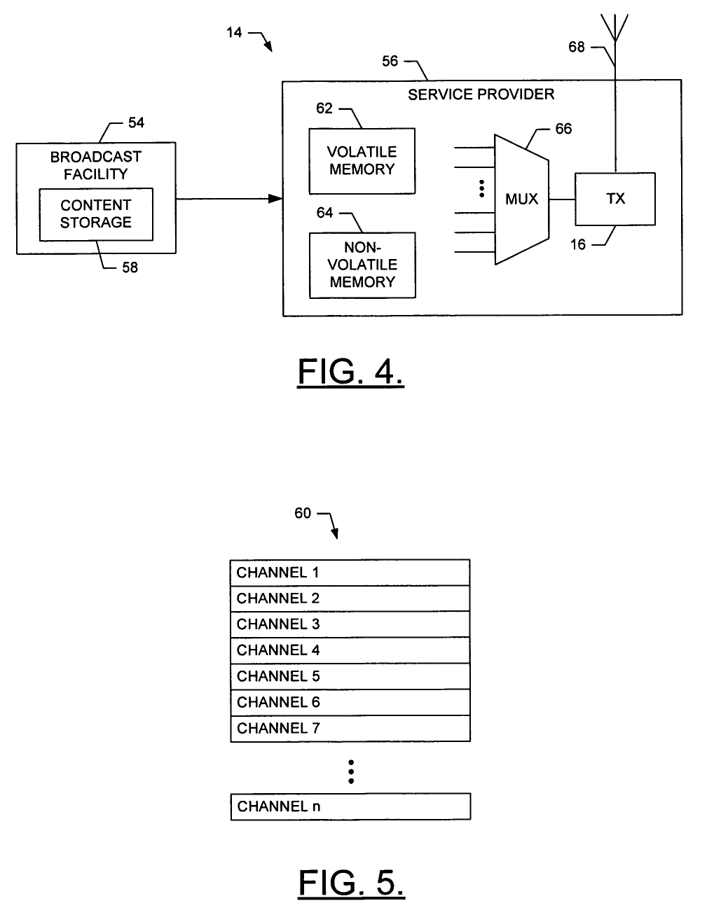

Reference is now made to FIG. 4, which illustrates a functional block diagram of the digital broadcaster 14 of one embodiment of the present invention. As shown, the digital broadcaster can include one or more broadcast facilities 54 capable of providing content to a digital broadcast service provider 56 for broadcast. Each broadcast facility can include volatile memory, such as volatile Random Access Memory (RAM) including a cache area for the temporary storage of data. The digital broadcaster can also include non-volatile memory, which can be embedded and/or may be removable. The non-volatile memory can additionally or alternatively comprise an EEPROM, flash memory, hard disk or the like. The memories can include, for example a content storage 58 for storing broadcast content, such as one or more channels of commercial and/or non-commercial broadcast television and/or radio content. In addition to including piece(s) of content stored in content storage, however, it should be understood that the broadcast facilities may also provide one or more channels of live broadcast content, such as news, sporting events or the like, which are incapable of being pre-stored in the content storage for any appreciable amount of time. Further, for example, the broadcast facilities may provide channels including pre-stored and live broadcast content, such as broadcast news content that can include one or more pre-stored news stories as well as live news anchor narratives for the news stories. Irrespective of whether the content is pre-stored or live, however, the digital broadcaster of one exemplary embodiment may broadcast such content over n ordered channels, as shown in the channel listing 60 of FIG. 5.

Like the digital broadcast receiving terminal 18, the digital broadcast service provider 56 of the digital broadcaster 14 can include volatile memory 62, such as volatile Random Access Memory (RAM) including a cache area for the temporary storage of data. The digital broadcaster can also include non-volatile memory 64, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels, as such can be provided by the broadcast facilities 54.

The digital broadcast service provider 56 of the digital broadcaster 14 can also include a multiplexer 66, which can be capable of multiplexing content for a number of television, radio and/or data channels, such as those provided by the broadcast facilities 54. In this regard, the multiplexer can be capable of multiplexing content for broadcast in accordance with a schedule 60 stored in content storage 58 of a broadcast facility. The multiplexer can then feed the resulting signal into a TX 16, which can be separate from the digital broadcaster, or more particularly the digital broadcast service provider, as shown in FIG. 1, or incorporated within the digital broadcaster, as shown in FIG. 4.

Irrespective of where the TX 16 is located relative to the digital broadcaster 14, the TX can receive the signal from the multiplexer 66 for encryption, modulation, amplification and/or transmission, such as via an antenna 68. For example, the digital broadcaster can be capable of directly or indirectly transmitting content to a digital broadcast receiving terminal 18 and/or a terminal 10, such as in accordance with a digital broadcasting technique, such as DVB-T. In this regard, the digital broadcaster can be capable of transmitting broadcast content, including one or more pieces of broadcast content stored by the content storage 58 of the broadcast facility 54, and/or one or more pieces of live broadcast content, in accordance with the times specified for the respective pieces of content in a schedule 60 stored by the content storage 58. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-H, Internet Protocol (IP) Datacasting (IPDC) can be utilized to provide audio, video and/or other content to terminals 10. In this regard, the digital broadcaster 14 can be capable of providing IP datacasting content to the terminal utilizing a digital broadcasting technique. DVB-H, for example, uses MPEG-2 transport streams, and as such, IP data can be encapsulated into DVB transmission signals sent from the digital broadcaster, or more particularly the TX 16. Data streams including IP datagrams can be supplied from several sources, and can be encapsulated by an IP encapsulator (not shown). The IP encapsulator, in turn, can feed the encapsulated IP data streams into the digital broadcasting (e.g., DVB-H) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, may be uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

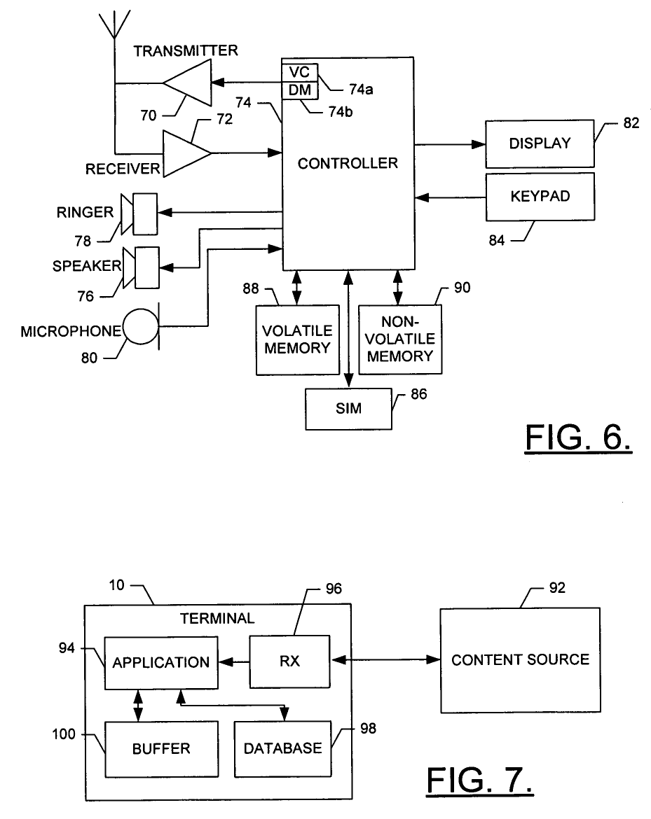

FIG. 6 illustrates a functional diagram of a mobile station that may operate as a terminal 10, according to exemplary embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 6, the mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, IS-95 (CDMA) or the like. Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74a, and may include an internal data modem (DM) 74b. Further, the controller may include the functionally to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station. For example, the keypad can additionally or alternatively include directional keys (↑, ↓) for directionally selecting ordered items, such as ordered channels of content.

The mobile station can further include memory, such as a subscriber identity module (SIM) 86, a removable user identity module (R-UIM) or the like, which may store information elements related to a mobile subscriber. In addition to the SIM, the mobile station can include other memory. In this regard, like the digital broadcast receiving terminal 18 and the digital broadcaster 14, the mobile station can include volatile memory 88. Also, again like the digital broadcast receiving terminal and the digital broadcaster, the mobile station can include other non-volatile memory 90, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 86, 88, 90 can store any of a number of pieces of information, and data, used by the mobile station to implement the functions of the mobile station. For example, the memories can store an identifier, such as an international mobile equipment identification (IMEI) code, capable of uniquely identifying the mobile station. The memories can also store one or more client applications, such as a conventional text viewer, audio player, video player, multimedia viewer or the like, for consuming content for one or more television, radio and/or data channels. As indicated above, although the client application(s) may comprise software operated by the respective entities, one or more such applications may alternatively comprise firmware or hardware.

As indicated in the background section, when a digital broadcaster broadcasts television, radio and/or data content over n ordered channels, as shown in the channel listing 60 of FIG. 5, an end user (e.g., terminal user) may desire to browse or otherwise channel hop through the available channels to select a desired channel to receive and consume (e.g., display, play, etc.). However, because channels may be broadcast in bursts that include time-sliced content for those channels, users moving from one channel to the next may experience a time delay (i.e., channel tuning time) dependent upon the burst interval as well as a number of other delays. Undesirably, such time delays can last up to ten seconds or more. And whereas techniques for buffering content for channels on either side of the currently selected channel reduce the time delay, such techniques also reduce the power saving benefits of broadcasting channels in time-sliced bursts, and may not even be possible to fully achieve with current receiver performance. Further, such conventional techniques may require a user to forego consumption of content for a channel during a channel hopping sequence should the user choose to channel hop.

To decrease the delay associated with channel hopping without incurring the reduction in power saving experienced in buffering channels on either side of a selected channel, the terminal 10 of exemplary embodiments of the present invention is capable of providing controlled buffering of channels of content during channel hopping. Generally, controlled buffering of channels is based upon the premise that end users may only infrequently channel hop. And when end users do channel hop, they do so via directional keys (hard and/or soft keys) (e.g., keypad keys (↑, ↓)), as opposed to via a channel guide or other means (e.g., conventional numeric keys (0-9)) for directly selecting channels by number. In this regard, when users channel hop, they also do so in one direction or another (increasing or decreasing in channel order).

Based upon the preceding premises, then, the terminal 10 of exemplary embodiments of the present invention includes a buffer memory that may remain empty while the terminal receives and consumes content for a selected channel, where the selected channel is one of a plurality of ordered channels. During such consumption, the terminal may be directed to enter a recording mode and begin recording content for the selected channel, where the recorded content may be stored in a database of the terminal. Then, when the terminal user selects a channel adjacent the selected channel, thereby initiating a channel hopping sequence, the terminal begins to buffer content for one or more next adjacent channels in the same direction from the selected channel. Exemplary embodiments of the present invention are therefore capable of at least partially buffering channels of content during a channel hopping sequence, without requiring the terminal to continuously buffer channels on either side of a selected channel. In addition, exemplary embodiments of the present invention are capable of recording content for the selected channel before, during and/or after the channel hopping sequence, thereby permitting the terminal to subsequently consume content received by the terminal before, during and/or after the channel hopping sequence.

If the terminal user continues to channel hop in the same direction by selecting a buffered channel, that channel can be initially pulled from the buffer memory, thereby avoiding the delay associated with first receiving content for that channel from the next content burst. The terminal 10 can continue to buffer next adjacent channel(s) as the terminal user channel hops, but otherwise clears the buffer if a timeout period passes without the terminal user selecting a next channel. Thus, by clearing the buffer and operating without it while the terminal is receiving and consuming content for a channel for more than a timeout period, exemplary embodiments of the present invention are capable of achieving the full benefits of power saving resulting from delivering content in time-sliced bursts.

Also, as the terminal user channel hops, the terminal 10 can continue to record content for one or more channels in the recording mode, initializing a recording timeout for the recording mode channel(s) when the terminal user channel hops from the respective channel(s), and if so desired, resetting the recording timeout when the terminal user returns to the respective channel(s). The terminal can continue to record content for the recording mode channel(s) as the terminal user channel hops, but otherwise stops recording content for one or more recording mode channels if the recording timeout period for those respective channel(s) passes without the terminal user returning to the respective channel(s). If the terminal user does return to a recording mode channel, the terminal can consume content for the recording mode channel as the terminal receives content for the respective channel, and subsequently consume the recorded content for that channel. By way of example, the terminal may be directed to consume currently broadcast content before consuming the previously broadcast and recorded content. Additionally or alternatively, the terminal can be directed to first consume recorded content for the recording mode channel, while the terminal continues to record content for the respective channel as the terminal receives such content. In such instances, the terminal can consume broadcast content for the channel received after the terminal user channel hopped to other channels and after the terminal user returned to the channel in a sequential manner.

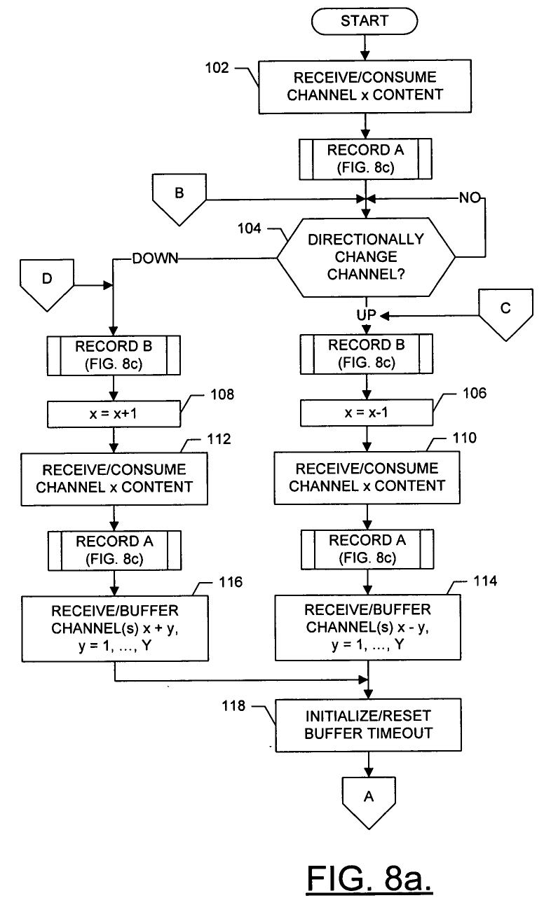

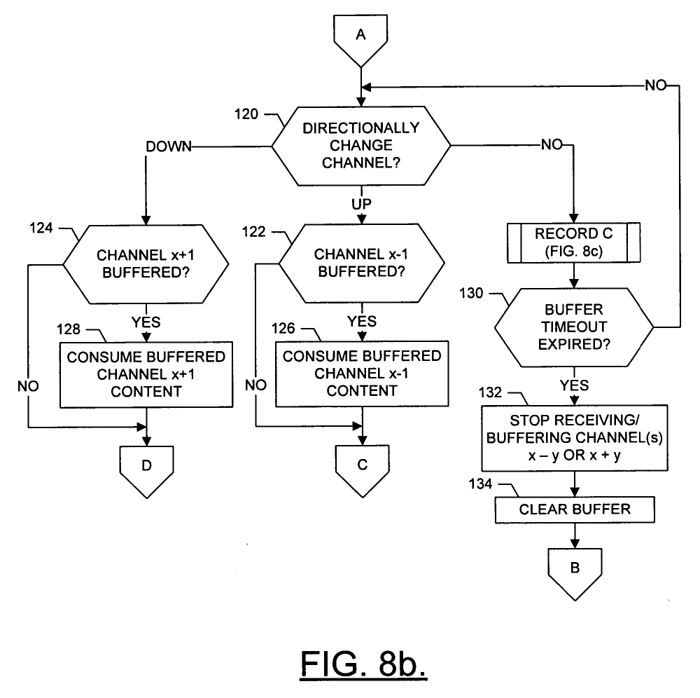

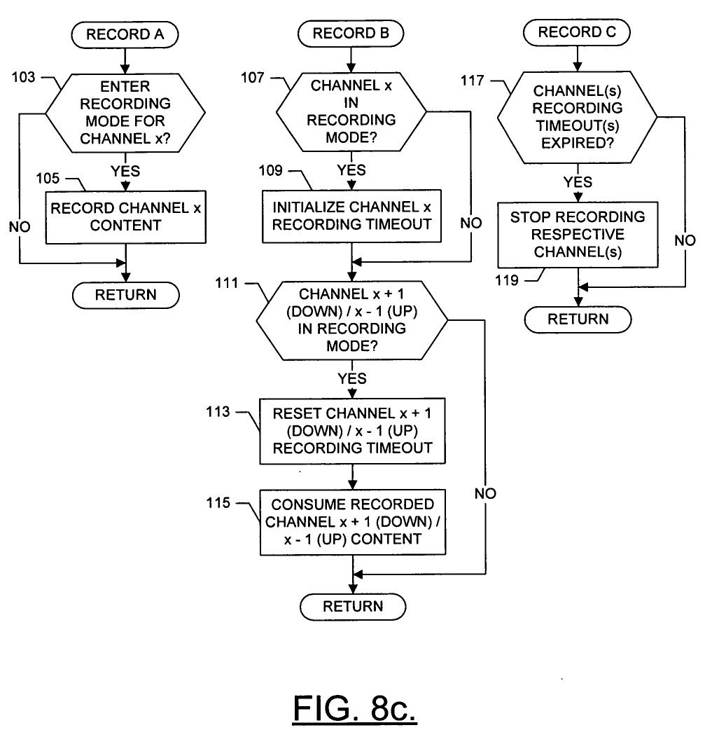

Reference is now drawn to FIGS. 7, 8a, 8b and 8c, which illustrate a functional block diagram and flowchart, respectively, of a terminal 10 and method of recording broadcast content to the terminal, in accordance with one embodiment of the present invention. More particularly, FIG. 7 illustrates a functional block diagram of a terminal receiving, from a content source 92, broadcast content for one or more channels of a set of ordered channels. Whereas the content source described below comprises a digital broadcaster 14, it should be understood that the content source can comprise any of a number of different sources (e.g., digital broadcast receiving terminal 18, etc.) capable of broadcasting content in accordance with exemplary embodiments of the present invention. Also, as described below, the terminal described herein with respect to the embodiment of FIGS. 7, 8a, 8b and 8c may comprise terminal 10. It should be understood, however, that the terminal can equally comprise a digital broadcast receiving terminal, without departing from the spirit and scope of the present invention. Further, although the broadcast content may be described as being that for one or more television and/or radio channels. It should be understood that the broadcast content can comprise any of a number of different types of content, and can be received at the terminal in accordance with any of a number of different wireline and/or wireless transfer techniques.

As shown in FIG. 7, the terminal 10 can operate a client application 94, such as a mobile TV application, for receiving and consuming (e.g., playing) content for a selected channel x of a plurality of ordered channels. After executing or otherwise activating the client application, a terminal user can direct the client application to receive and consume content for a selected channel, as shown in block 102 of FIG. 8a. For example, the client application can be configured to present a user interface (UI) including a channel listing 60 from which the user can select a desired channel. Irrespective of how the client application is directed to receive and consume content for a selected channel x, the application thereafter receives the selected channel content from a content source 92 via a receiver (RX) 96 of the terminal. The receiver can receive the selected channel content from the content source in accordance with any of a number of different transfer techniques such as, for example, techniques specified by DVB, GPRS, EDGE or the like. And the selected channel content can comprise content stored by the content storage 58 maintained by a broadcast facility 54 providing such content to the digital broadcaster 14.

As the client application 94 receives and consumes content for the selected channel x, the terminal user may decide to enter or otherwise place the selected channel x or another channel in a recording or alert mode (individually or collectively referred to as the recoding mode). In such instances, the terminal user may direct the client application to record received or anticipated (scheduled) content for the selected channel x or another channel, and/or alert the user of the anticipated content for the selected channel x or another channel, as shown in blocks 103 and 105 of FIG. 8c. With selected channel x placed in the recording mode, the client application can then record content for the selected channel x or another channel, and store the recorded content in a database 98 (e.g., within memory 30, volatile memory 48, non-volatile memory 50, volatile memory 88, non-volatile memory 90, etc.).

Also as the client application 94 receives and consumes content for the selected channel x, the terminal user may decide to directionally browse the content of other channels. More particularly, the terminal user may decide to at least temporarily receive content for a channel up (−) or down (+) from the selected channel x in the ordered set of channels. For example, the terminal user may decide to change the channel to channel x−1 (up from the selected channel) or channel x+1 (down from the selected channel), such as by depressing an appropriate directional key (↑, ↓), as shown in block 104 of FIG. 8a. In such instances, if channel x is in the recording mode, the client application can initialize a recording timeout for channel x, as shown in blocks 107 and 109. The recording timeout can comprise any of a number of different time periods, such as from thirty seconds to a minute or more. As explained below, expiration the recording timeout can be utilized by the client application as indicative of the user no longer being interested in the content for channel x such that the client application can stop recording channel x content.

As expiration of the recording timeout may be indicative that the user is no longer interested in the content for channel x, returning to a channel in the recording mode during the duration of the recording timeout period may be indicative that the user remains interested in recording content for that channel. Thus, if the newly selected channel x−1 or x+1 is in the recording mode (i.e., previously placed in the recording mode), the client application 94 can reinitialize or otherwise reset the recording timeout for the respective channel, as shown in blocks 111 and 113, by returning to channel x−1 or x+1, even if just momentarily. It should be understood, however, that the recording timeout can be reinitialized or otherwise reset in any of a number of other manners, such as by notifying the terminal user of the impending expiration of a recording timeout and receiving direction from the user to reset the respective recording timeout. Further, since the client application may be recording content for a newly selected channel x−1 or x+1 in the recording mode, the client application can (but need not) be directed to consume the recorded and stored content for the respective channel while continuing to record content for the channel, as shown in block 115 of FIG. 8c. In this regard, by consuming content for the newly selected channel from the database 98 while continuing to record content for that channel, the client application can provide content to the user in the order in which that content was broadcast to, and thus received by, the terminal 10.

After changing channels to an adjacent channel, the adjacent channel x−1 or channel x+1 becomes the selected channel (i.e., x=x−1 or x=x+1), with channel x becoming the previously selected channel, as shown in blocks 106 and 108 of FIG. 8a. The client application can then operate to receive and consume content for the newly selected channel x, as shown in blocks 110 and 112. In addition, as before, at any point during receipt and consumption of content for the newly selected channel x, newly selected channel x may be entered or otherwise placed in the recording mode such that received content for the selected channel x is recorded and stored in the database 98 (see blocks 103 and 105 of FIG. 8c). It should be understood, however, that the client application 94 receiving and consuming content for the newly selected channel presumes that the newly selected channel is available for the client application to receive and consume. In various instances, it may be the case that the previously selected channel is the only channel available to the terminal user, and thus the terminal 10 and client application. In such instances, the client application may receive an indication from the content source 92 that the newly selected channel is unavailable for receipt and consumption by the terminal. The client application can then respond in any of a number of different manners, such as by communicating the indication, and/or other content reflective of the newly selected channel being unavailable, to the terminal user via a user interface of the terminal (e.g., display 34, display 82, etc.).

Presuming a plurality of channels are available for receipt and consumption by the client application 94, however, in accordance with exemplary embodiments of the present invention, directing the client application to change channels to an adjacent channel not only causes the client application to receive content for that channel, but also for one or more of the next adjacent channels based upon the direction of the channel change. While the client application consumes content for the selected channel, however, the client application not only does the client application record content for channel(s) in the recording mode, but also stores the next adjacent channel(s) in a buffer memory 100 (e.g., within memory 30, volatile memory 48, non-volatile memory 50, volatile memory 88, non-volatile memory 90, etc.). More particularly, when the client application is directed to receive and consume content for a selected channel x up (−) from the previously selected channel, the client application also receives and buffers content for channel(s) x−y, where y=1, . . . , Y and represents each of Y (e.g., 1) next adjacent channels buffered, as shown in block 114. Conversely, when the client application is directed to receive and consume content for a selected channel x down (+) from the previously selected channel, the client application receives and buffers content for channel(s) x+y, as shown in block 116.

In addition to receiving and recording content for channel(s) in the recording mode, receiving and consuming content for the newly selected channel x, and receiving and buffering content for the next adjacent channel(s) x−y or x+y, the client application 94 may also initialize a buffer timeout, as shown in block 118. The buffer timeout can comprise any of a number of different time periods, such as from thirty seconds to a minute or more. As explained below, the buffer timeout can be utilized by the client application to determine when the user has stopped channel hopping such that the client application can clear the buffer memory and cease to buffer content.

Irrespective of the length of the buffer timeout, during this period, the user may continue to channel hop by browsing channels adjacent the newly selected channel, as explained below. More particularly, during the timeout period, the terminal user may again decide to change the channel to channel x−1 (up from the selected channel) or channel x+1 (down from the selected channel), such as by again depressing an appropriate directional key (↑, ↓), as shown in block 120 of FIG. 8b. In such instances, when the terminal user changes the channel in the same direction as before, content for the newly selected channel is buffered in memory. That is, if the terminal user previously changed the channel from channel x to channel x−1 (channel x−1 now the selected channel x), and then changes the channel in the same direction to channel x−1, content for that newly selected channel is buffered in memory 100. Similarly, if the terminal user previously changed the channel from channel x to channel x+1 (channel x+1 now the selected channel x), and then changes the channel in the same direction to channel x+1, content for that newly selected channel is buffered in memory.

If content for the newly selected channel x−1 or x+1 is buffered in memory 100, the client application 94 consumes the buffered content for the newly selected channel before the client application receives content for that channel from the content source 92, as shown in blocks 122 and 126 for selecting channel x−1, and blocks 124 and 128 for selecting channel x+1. In this regard, by consuming content for the newly selected channel from buffer memory before the client application receives that channel's content from the content source, the client application can provide content with a reduction in, if not elimination of, delay otherwise associated with initially receiving content for a selected channel.

After consuming the buffered content, or if content for the newly selected channel x−1 or x+1 is not buffered in memory 100, the client application 94 proceeds, as before, to initialize or reset the recording timeout of channel x, and/or channel x−1 or channel x+1, if the respective channel(s) are in the recording mode (see blocks 107-113 of FIG. 8c). In addition, the client application can (but need not) proceed to consume the recorded and stored content for a newly selected channel in the recording mode (see block 115 of FIG. 8c). Further, the client application can proceed to set the newly selected channel as the selected channel (i.e., x=x−1 or x=x+1), with channel x becoming the previously selected channel (see blocks 106 and 108). The client application can then, as before, operate to receive and consume content for the newly selected channel x (see blocks 110 and 112). It should be appreciated, however, that if the client application does not first consume content for the newly selected channel from buffer memory, the client application may experience a delay in receiving, and thus consuming, content for the newly selected channel.

Also similar to before, while the client application receives and consumes content for the selected channel, the client application also receives and records content for channel(s) in the recording mode, and receives and buffers content for channel(s) x−y or x+y (see blocks 114 and 116). In this regard, the client application receives and buffers content depending on the direction the terminal user changed the channel from the previously selected channel (i.e., depending on whether the terminal user changed the channel up (−) or down (+) from the previously selected channel). Further, the client application can reinitialize or otherwise reset the buffer timeout (see block 118).

The terminal user can continue to channel hop in the manner explained above, such as until the terminal user decides to remain tuned to, and thus receive and consume content for, a desired selected channel x. When the terminal 10 remains tuned to a selected channel x for a period exceeding the recording timeout of one or more channels in the recording mode (other than the selected channel x if that channel is also in the recording mode), the recording timeout for those channel(s) expires without being reinitialized or reset, as shown in block 117 of FIG. 8c. Upon expiration of the recording timeout for one or more channels in the recording mode, the client application 94 can respond in any of a number of different manners. For example, the client application can stop or otherwise cease recording content for the respective channel(s), as shown in block 119. Additionally, the client application can (but need not) clear or otherwise delete the recorded content for the respective channel(s) stored in the database 98.

Also, when the terminal 10 remains tuned to a selected channel x for a period exceeding the buffer timeout (before, after or as the recording timeout of any channel(s) expires), the buffer timeout expires without being reinitialized or reset, as shown in block 130. Upon expiration of the buffer timeout, the client application 94 can respond in any of a number of different manners. For example, the client application can stop or otherwise cease buffering content for channel(s) x−y or x+y, as shown in block 132. Additionally, the client application can clear, or otherwise delete the content stored in, the buffer memory 100, as shown in block 134. The client application can then continue, as before, receiving and consuming content for the desired selected channel x, and waiting for the user to again select to change the channel (see block 104).

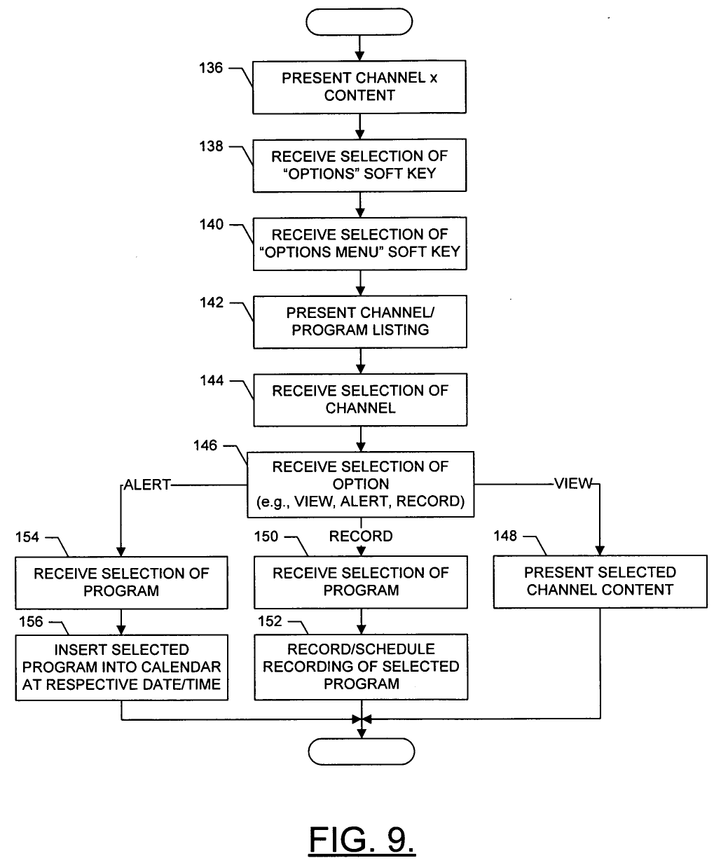

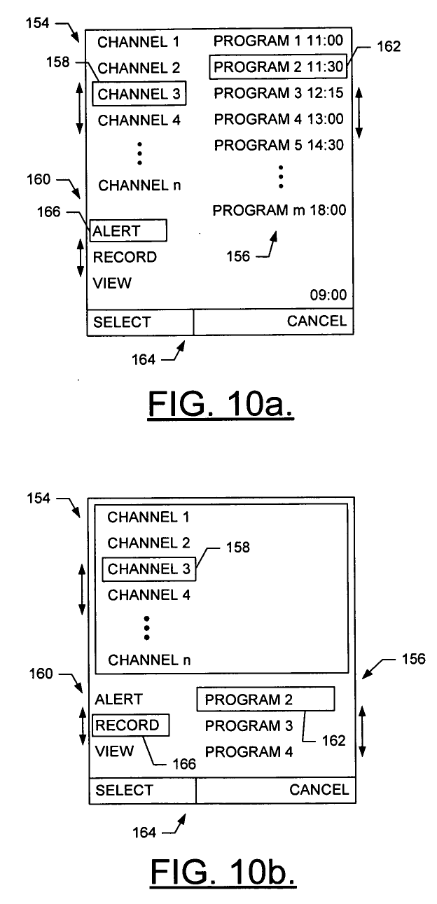

To further illustrate the user interface benefits of exemplary embodiments of the present invention, reference is now made to the flowchart of FIG. 9, and the exemplary displays of FIGS. 10a and 10b. As shown in block 136 of FIG. 9, as the terminal 10 consumes, plays or otherwise presents content for channel x, the terminal may also present one or more soft keys including, for example, an “options” soft key. During presentation of the channel x, content, then, the terminal may receive selection of the “options” soft key from the terminal user, as shown in block 138. Upon receiving selection of the “options” soft key, the terminal can present a pop-up window display including channels of a channel listing and/or programs for the respective channels, as shown block 142 and in the alternative arrangements of FIGS. 10a and 10b, for example.

As shown in FIGS. 10a and 10b, an options pop-up window display can include a window portion 154 with a number of channels of the channel listing, and/or a window portion 156 with a number of programs (past, current and/or scheduled) for a selected channel 158. The pop-up window can also include a window portion 160 with one or more selectable options with respect to the selected channel and/or a selected program 162 of the selected channel. In addition, the pop-up window can include a window portion 164 that can include soft keys (e.g., “select,” “cancel,” etc.) for selecting or canceling selection of a channel, program or option from the respective windows of the pop-up window, a selected option being shown with reference to callout 166.

After presenting the pop-up window display, the user may navigate the window portions 154, 156, 160, 164 to select a channel, program and/or option. More particularly, and again referring to FIG. 9, the terminal user can browse the channels of the channel listing window portion 154, such as via directional keys (hard and/or soft keys) (e.g., keypad keys (↑, ↓)), to select a channel. The terminal user can then select, and the terminal 10 can receive selection of, a channel from the channel listing window, as shown in block 144. The user can then select from among the available options for the selected channel 158, such as to view content for the selected channel (e.g., “view”), create an alert for program content scheduled for the selected channel (e.g., “alert”), or record current or scheduled content for the selected channel (e.g., “record”). If the user selects, and the terminal receives a selection, to view content for the selected channel, the terminal can present the content for the selected channel, such as by receiving and consuming content for the selected channel.

If the user selects, and the terminal 10 receives a selection, to either create an alert or record content for a channel, the user may next browse current and/or scheduled content or programs for the selected channel 158 from within the program listing window portion 156, such as via directional keys (e.g., keypad keys (↑, ↓)), to select a program. In this regard, content or programs may be presented in the program listing window in any of a number of different manners, such as by name and time (see FIG. 10a), type of content or program (see FIG. 10b, e.g., “hockey game,” “news,” “soap opera”), or the like. Irrespective of how the content or programs are presented, the terminal user can then select, and the terminal can receive selection of, a program from the program listing window, as shown in block 150 for recording the selected program 162, and in block 154 for creating an alert with respect to the selected program.

Following selection of a program or content for recording, the terminal 10 can record selected, currently broadcast content or program 162, or schedule recording of a selected, anticipated (scheduled) content or program, as shown in block 152. When the selected option 166 is for creating an alert, on the other hand, the terminal can insert the selected content or program into a calendar application operable on the terminal at the date/time the selected content or program is scheduled for broadcast as shown in block 156. The calendar application may then be configured to present an alert, such as an audio, visual or audio-visual alert, to the terminal user at one or more instances prior to and/or during broadcast of the selected content or program.

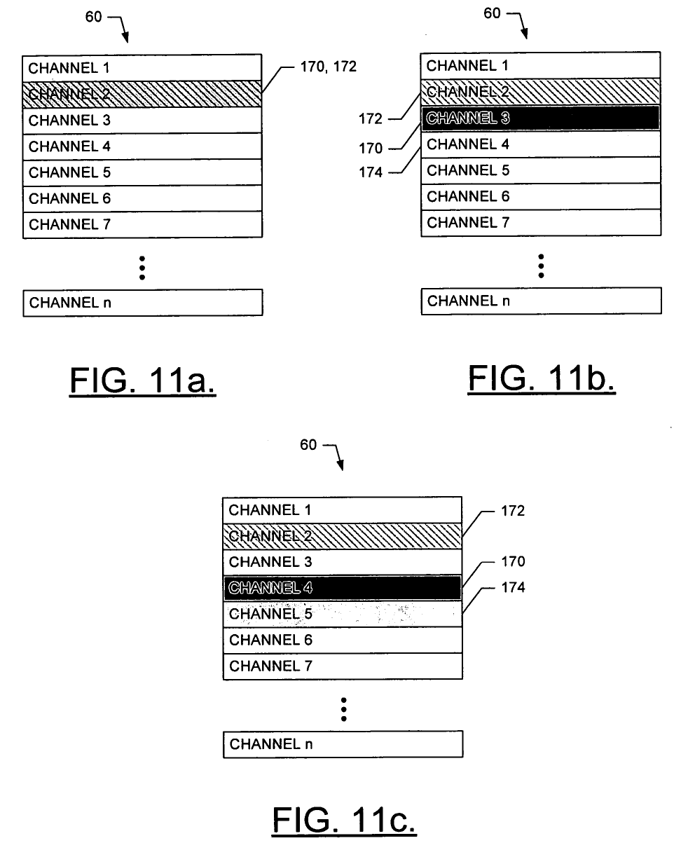

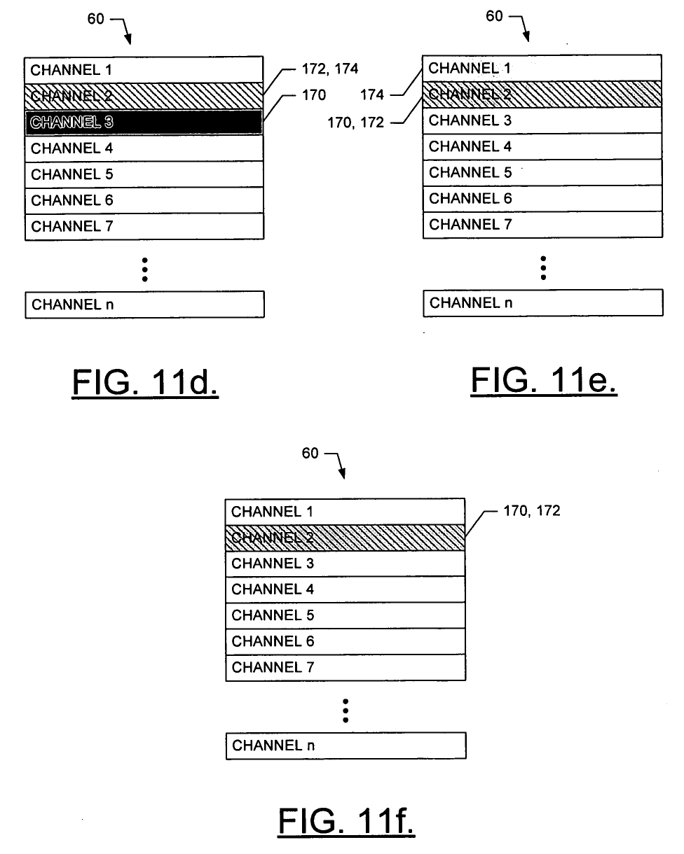

To now further illustrate the operational benefits of exemplary embodiments of the present invention, consider the exemplary channel listings 60 of FIGS. 11a-11f. In this regard, as illustrated in FIG. 11a, the client application 94 is receiving and consuming (i.e., playing) content for channel 2, where channel 2 is the selected channel 170. As the client application receives/consumes content for channel 2 (i.e., channel x), the terminal user places channel 2 in the recording mode such that the client application records and stores channel 2 content, where channel 2 is now a channel 172 in the recording mode. The terminal user then decides to channel hop around the channel listing to see what content is available on the other channels. Thus, the user changes the channel down (+) from channel 2 to adjacent channel 3 (i.e., channel x+1) by depressing a directional key ↓ of the terminal 10. The client application continues to receive and record channel 2 content, although changing the channel causes the client application to initiate a channel 2 recording timeout. Channel 3 then becomes the selected channel 170, and channel 2 becomes the previously selected channel.

Also in response to the terminal user changing the channel to channel 3, the client application 94 begins to receive and consume content for channel 3. In addition, the client application also begins to receive content for the next adjacent channel 174, namely channel 4 (i.e., x+y, y=1), as shown in FIG. 11b. Instead of consuming content for channel 4, however, the client application buffers the content for channel 4 to memory 100. Thus, presume the user again decides to change the channel down (+) from the selected channel 3 to adjacent channel 4, changing the channel in the same direction as before, as shown in FIG. 11c. As the client application is buffering content for channel 4, the client application can consume the buffered content until the client application can receive content for channel 4, such as during the next burst of time-sliced content. The client application can then transition into receiving and consuming content for channel 4 from the content source 92.

As also shown in FIG. 11c, as the client application 94 receives and consumes content for newly selected channel 4, the client application receives and buffers content for the next adjacent channel, i.e., channel 5, and may continue to receive and record content for channel 2 as it remains in the recording mode. Thus, if the terminal user yet again decided to change the channel down (+) to channel 5, the client application could initially consume the buffered content for channel 5 before receiving and consuming content from the content source 92. On the other hand, consider that the user now decides to change the channel up (−) from the selected channel 4 to next adjacent channel 3 by depressing directional key ↑, changing the channel in the opposite direction as before, as shown in FIG. 11d. In this instance, the client application receives and consumes content for the newly selected channel 3 without first consuming content from the buffer memory 100. Accordingly, the client application may experience some delay in receiving the content for channel 3 from the content source.

Now, as the client application 94 receives and consumes content for newly selected channel 3, the client application may receive and buffer content for the next adjacent channel, i.e., channel 2. Alternatively, the client application may recognize that channel 2 is in the recording mode with its content already being recorded and stored, and in lieu of buffering content for channel 2 in buffer memory 100, store a reference in buffer memory to the channel 2 content stored in database 98 (or generally flag the stored content as corresponding to a buffered adjacent channel). As shown in FIG. 11e, then, presume the terminal user again decides to change the channel up (−) from the selected channel 3 to the next adjacent channel 2. As the client application is buffering content for channel 2, the client application can consume the buffered content until the client application can receive content for channel 2, thereby reducing any time delay otherwise associated with receiving content for channel 2. Alternatively, as channel 2 is in the recording mode, the client application can consume the stored content until the client application can receive content for channel 2. Irrespective of the client application consuming buffered content in buffer memory 100 or stored content in database 98, the client application can also continue to receive and record the content for channel 2, as well as reset the channel 2 recording timeout upon changing the channel. Thus, the client application can be directed to consume further previously stored content such that the client application consumes broadcast content for the channel received after the terminal user channel hopped to other channels and after the terminal user returned to the channel in a sequential manner. Then, as the client application receives and consumes content for newly selected channel 2, the client application also receives and buffers content for the next adjacent channel 1.

The terminal user can continue to channel hop the n channels of the channel listing 60, such as until the user decides to remain on a desired selected channel. As shown in FIG. 11f, for example, presume the user decides to remain on channel 2. Thus, the recording timeout may also expire such that the client application ceases to record content for channel 2. Alternatively, resetting the recording timeout may include holding the recording timeout until such time as the channel is changed from channel 2, thereby maintaining channel 2 in the recording mode (unless otherwise taken out of the recording mode by the terminal user). In addition, after the buffer timeout expires, the client application 94 can cease to buffer content for the next adjacent channel 1 (see FIG. 11e). In addition, the client application can reset the buffer memory 100, thereby reducing memory consumption of the terminal 10.

As shown and described herein, during instances in which the terminal user channel hops to adjacent channels, the client application 94 buffers content for one or more next adjacent channels. It should be understood, however, that the client application may additionally or alternatively be configured to buffer channels of content in one or more other manners. For example, the client application may be configured to additionally or alternatively buffer content for the previously selected channel, irrespective of whether the newly selected channel is adjacent to the previously selected channel. Accordingly, the terminal user may toggle between the two channels, where the content for one of the channels is received and buffered while the content for the other channel is received and consumed.

Additionally or alternatively, the client application 94 may be configured of additionally or alternatively buffer content in accordance with channel usage statistics associated with the terminal user. For example, the client application can be configured to store a log of channels for which the terminal user directs the client application to receive and consume content. From such a log, the client application can compute various statistics regarding channel usage of the terminal user, such as to identify one or more channels for which the terminal user frequently directs the client application to receive and consume content, as compared to receiving and consuming content for one or more other channels. These channels, then, can be referred to as “preferred channels.” Thus, during instances in which the channel user channel hops various channels (irrespective of the direction or location of the various channels), the client application can be configured to additionally or alternatively buffer content for one or more of the preferred channels. By buffering content for those preferred channels, exemplary embodiments of the present invention may be additionally or alternatively configured to buffer content for channels that may not be adjacent or next adjacent a selected channel.

In another additional or alternative configuration, the client application 94 may buffer channels based upon a channel subscription model whereby the terminal user subscribes to receive and consume content for one or more channels. In such an instance, the terminal user may subscribe to consume fewer than all of the channels in the set of channels available from the content source 92. Then, when the terminal user changes the channel to channel x−1 (up from the selected channel) or channel x+1 (down from the selected channel), the client application may receive an indication that the newly selected channel and/or the next adjacent channel(s) are unsubscribed channel(s) or are otherwise inaccessible. More particularly in accordance with techniques such as DVB-H, for example, content for a plurality of channels is encrypted, and then broadcast in time-sliced bursts. In addition to the encrypted content for the plurality of channels, each burst also includes a key stream with an encrypted key for decrypting content for each channel. When a terminal user subscribes to a given channel, then, the terminal 10 receives a rights object (RO) with which a DRM engine of the terminal can decrypt the key for the given channel. The decryption module can then decrypt the encrypted content for the given channel with the decrypted key such that the client application can consume the decrypted content. Thus, when the DRM engine fails to decrypt the key for a newly selected channel or next adjacent channel(s) in response to the terminal user changing channels, the client application may receive an indication from the DRM engine (or decryption module) that the newly selected channel and/or the next adjacent channel(s) are unsubscribed channels.

The client application 94 can respond to the indication in any of a number of different manners. For an unsubscribed selected channel, for example, the client application can inform the terminal user that the selected channel is unsubscribed, such as by displaying an indication that the selected channel is unsubscribed, and/or other content reflective of the selected channel being unsubscribed (e.g., blank screen, invitation to subscribe to channel, etc.), via a user interface of the terminal (e.g., display 34, display 82, etc.). Additionally or alternatively, for example, the client application can automatically select one or more next adjacent channels until the client application reaches a subscribed channel, where that channel can be indicated by receipt of subscribed content for that channel. That channel, then, becomes the newly selected channel. Further, for example, the client application can buffer content for the next adjacent subscribed channel(s) from the newly selected channel, bypassing any intervening unsubscribed broadcast channel(s).

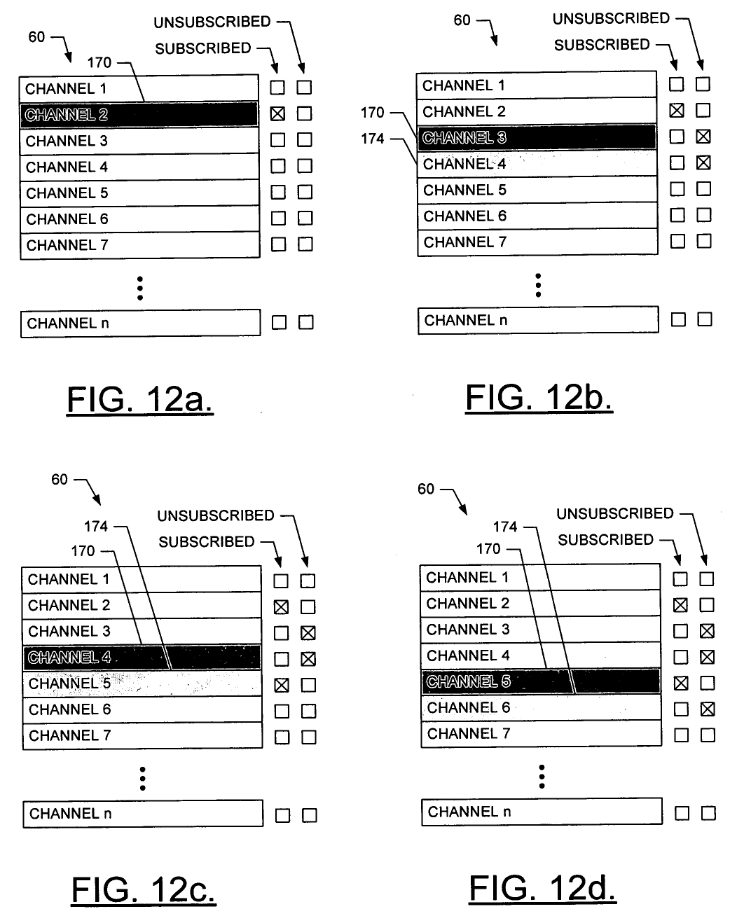

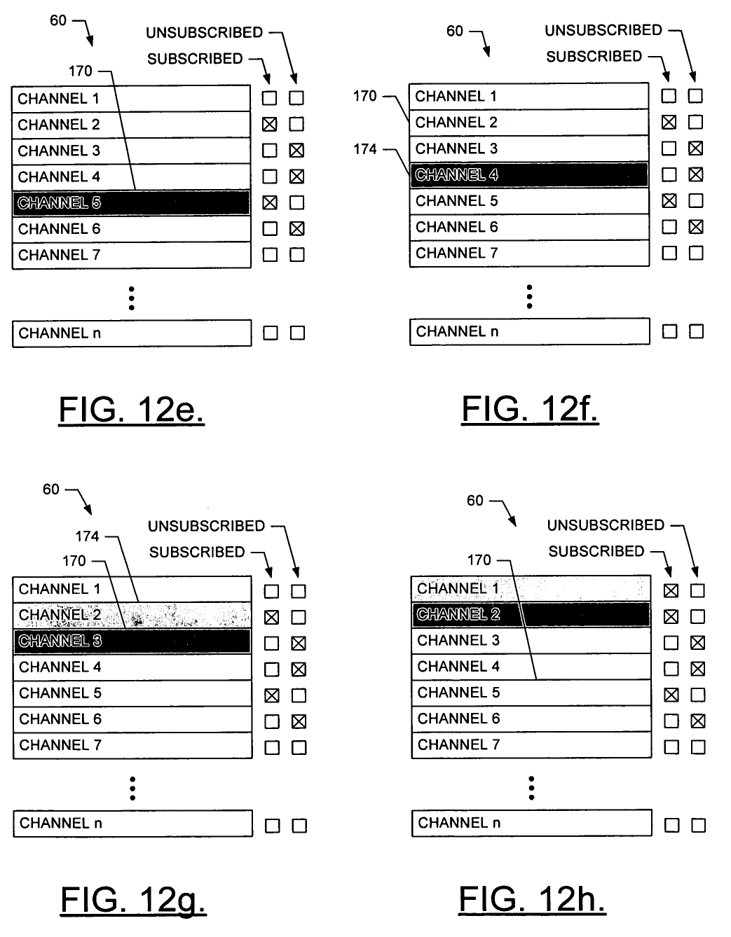

More particularly, for example, consider the channel hopping sequences represented by the channel listings 60 of FIGS. 12a-12h. As shown in FIG. 12a, similar to the channel listing of FIG. 11a, presume the terminal user selects channel 2 such that the client application 94 is receives and consumes (i.e., plays) subscribed content for channel 2, with channel 2 being the selected channel 170. In this regard, the client application can receive a burst of encrypted content for a plurality of channels, as well as a key stream including encrypted keys for decrypting encrypted content for respective channels. Upon receiving content for channel 2, then, the terminal DRM engine can use a RO to decrypt the key for channel 2. The decryption module can then use the decrypted key to decrypt content for channel 2 such that the client application can thereafter consume the decrypted content. In addition, the first instance of selecting channel 2 (or first instance in a given time period, communication session, etc.) the client application can flag channel 2 as being a subscribed channel, such as in a subscription log (represented by the illustrated check boxes), where decryption of content for channel 2 indicates a subscription to that channel, for example. As shown and described herein, one or more channels are flagged as subscribed channels or unsubscribed channels during the first instance of selecting the respective channels. It should be understood, however, that the client application may be preconfigured with the channels appropriately flagged. In such instances, the client application can operate based upon the flag for the first instance of selecting a channel (and from that channel the next adjacent channel(s)), as described below for subsequent instances of selecting a channel (and from that channel the next adjacent channel(s)).

As the client application receives/consumes content for channel 2 (i.e., channel x), presume the terminal user decides to channel hop around the channel listing to see what content is available on the other channels. Thus, the user changes the channel down (+) from channel 2 to adjacent channel 3 (i.e., channel x+1) by depressing a directional key ↓ of the terminal 10. Channel 3 then becomes the selected channel 170, and channel 2 becomes the previously selected channel. In response to the terminal user changing the channel to channel 3, the client application 94 tunes to channel 3 and receives encrypted content for that channel. For purposes of illustration, consider that channel 3 is an unsubscribed channel for the terminal user. Although the client application receives content for channel 3, the terminal DRM engine may fail to decrypt the key for channel 3, and accordingly the decryption module may fail to decrypt the content for channel 3. Thus, instead of consuming content for channel 3, however, the client application receives an indication from the DRM engine (or decryption module) that channel 3 is an unsubscribed channel (i.e., DRM engine failed to decrypt the key, or the decryption module failed to decrypt the content, for channel 3). The client application can then consume the indication and/or other content reflective of the channel being unsubscribed (e.g., blank screen, invitation to subscribe, etc.), such as by displaying the indication and/or other reflective content via a user interface of the terminal (e.g., display 34, display 82, etc.). Similar to the first instance of selecting channel 2, the client application can flag channel 3 as being an unsubscribed channel, for example.

In addition to receiving content for channel 3, the client application 94 also receives decrypted content for the next adjacent channel 174, namely channel 4 (i.e., x+y, y=1), as shown in FIG. 12b. Presuming that channel 4 is also an unsubscribed channel, like channel 3, the client application receives an indication from the DRM engine (or decryption module) that channel 4 is an unsubscribed channel, and for the first instance of selecting channel 4, flags channel 4 as being an unsubscribed channel. Instead of consuming the indication for channel 4, however, the client application buffers the indication and/or other reflective content (i.e., content reflective of the channel being unsubscribed) for channel 4 to memory 100. Although not shown, if so desired, the client application can then automatically select the next adjacent channel 5, and receive and buffer decrypted content for channel 5 if channel 5 is a subscribed channel (the decryption module using a decrypted key—decrypted by the DRM engine—to decrypt the content). Otherwise, if channel 5 is likewise an unsubscribed channel, the client application can continue to select next adjacent channels in a like manner until reaching the next adjacent subscribed channel, receiving and buffering content for that subscribed channel.

Presume the user again decides to change the channel down (+) from the selected channel 3 to adjacent channel 4, changing the channel in the same direction as before, as shown in FIG. 12c. As the client application 94 is buffering the indication and/or other reflective content for channel 4, the client application can consume the buffered indication and/or other reflective content for channel 4, such as in the same manner as the client application consumed the buffered indication and/or other reflective content for channel 3. As also shown in FIG. 12c, as the client application consumes the indication and/or other reflective content for newly selected channel 4, the client application receives and buffers content for the next adjacent channel, i.e., channel 5. Presuming channel 5 is a subscribed channel, the client application receives encrypted content for channel 5, which the decryption module decrypts with a key, which the DRM engine decrypted with an appropriate RO. The client application can then buffer the decrypted content for channel 5, and for the first instance of selecting channel 5, flags channel 5 as being a subscribed channel. Thus, if the terminal user yet again decided to change the channel down (+) to channel 5, the client application could initially consume the buffered content for channel 5 before receiving and consuming content from the content source 92, and likewise receive and buffer content for the next adjacent channel 6, as shown in FIG. 12d (channel 6 being shown as an unsubscribed channel such that the buffered content comprises an indication and/or other reflective content).

The terminal user can continue to channel hop the n channels of the channel listing 70, such as until the user decides to remain on a desired selected channel. As shown in FIG. 12e, for example, presume the user decides to remain on channel 5. Thus, after the buffer timeout expires, the client application 94 can cease to buffer content for the next adjacent channel 6 (see FIG. 12d). In addition, the client application can reset the buffer memory 100, thereby reducing memory consumption of the terminal 10.

Sometime after expiration of the buffer timeout, presume that the user decides to change the channel up (−) from the selected channel 5 to next adjacent channel 4 by depressing directional key ↑, changing the channel in the opposite direction as before, as shown in FIG. 12f. In this instance, the client application can tune to newly selected channel 4, and since channel 4 is an unsubscribed channel, receive encrypted content for channel 4, and consume an indication from the DRM engine (or decryption module) and/or other content reflective of channel 4 being an unsubscribed channel. Alternatively, having flagged channel 4 as an unsubscribed channel, the client application may store the indication and/or other reflective content for channel 4 in memory of the terminal (e.g., memory 30, 90, etc.). In such instances, in lieu of waiting for the DRM engine (or decryption module) to indicate that channel 4 is an unsubscribed channel, the client application may consume the indication and/or other reflective content from memory.

Having flagged the immediately adjacent channel 3 as an unsubscribed channel and thereby recognizing channel 3 as such, the client application bypasses channel 3 to arrive at the next adjacent subscribed channel 2. Now, as the client application 94 consumes the indication and/or other reflective content for newly selected channel 4, instead of buffering content for the next adjacent, unsubscribed channel 3, the client application receives and buffers decrypted content for the next adjacent subscribed channel, i.e., channel 2, as also shown in FIG. 12f (the decryption module being capable of decrypting content for channel 2 using a key previously decrypted by the DRM engine with an appropriate RO). As shown in FIG. 12g, then, presume the terminal user again decides to change the channel up (−) from the selected channel 4 to the next adjacent channel 3. Similar to selecting unsubscribed channel 4, the client application receive and consume an indication from the DRM engine (or decryption module) and/or other content reflective of channel 3 being an unsubscribed channel, or alternatively consume the indication and/or other reflective content for channel 3 from memory (if stored therein). As the next adjacent subscribed channel remains channel 2, the client application can continue to receive and buffer decrypted content for channel 2 (the decryption module having decrypted the content). Then, should the terminal user decide to change the channel up (−) to channel 2, the client application can consume the buffered decrypted content until the client application can receive content for channel 2, thereby reducing any time delay otherwise associated with receiving content for channel 2.

In addition to or in lieu of the foregoing alternative configurations of the client application 94, the client application may, for example, be configured to receive a schedule at one or more instances, where the schedule includes one or more slots specifying broadcast times, including dates, for content broadcast for one or more channels over a period of time (e.g., year, month, week, day, etc.). In such instances or in a number of other instances, when a channel is placed in the recording mode, in addition to or in lieu of recording content currently broadcast and received for the respective channel, the client application can be configurable to receive selection of content scheduled for future broadcast on the respective channel. The client application can then receive and record the selected content at the scheduled broadcast time. As will be appreciated, however, the client application may hold the channel 2 recording timeout as the scheduled broadcast time for the selected content may extend beyond the recording timeout.

Also in such instances or in a number of other instances, the client application 94 can be configurable to receive selection of one or more channels of content scheduled for broadcast at one or more future broadcast times. Then, at one or more instances leading up to the respective broadcast time(s), the client application can present the terminal user with a reminder of the impending broadcast of content for the respective channel(s), such as via a user interface of the terminal (e.g., display 34, display 82, etc.). For one or more of those reminders, the client application can additionally present a selection for the terminal user to select to change the channel to a respective channel. The client application can then be configured to additionally or alternatively buffer content for the respective channel such that, if the terminal user selects to change the channel to the respective channel, the client application can consume the buffered content for the respective channel before receiving and consuming content for the respective channel from the content source 92.

As further shown and described herein, the set of channels and ordering of those channels is defined by the content source 92. It should be understood, however, that the terminal user can alter, via the client application 94, the set of channels and/or ordering of channels defined by the content source. In such instances, then, the set and ordering of channels utilized by the client application to identify the adjacent and next adjacent channel(s) may (but not always) comprise the set and/or ordering as altered by the terminal user. The channel set and ordering described above, then, may more generally be user-defined in that the set and/or ordering defined by the content source is modified by the terminal user.

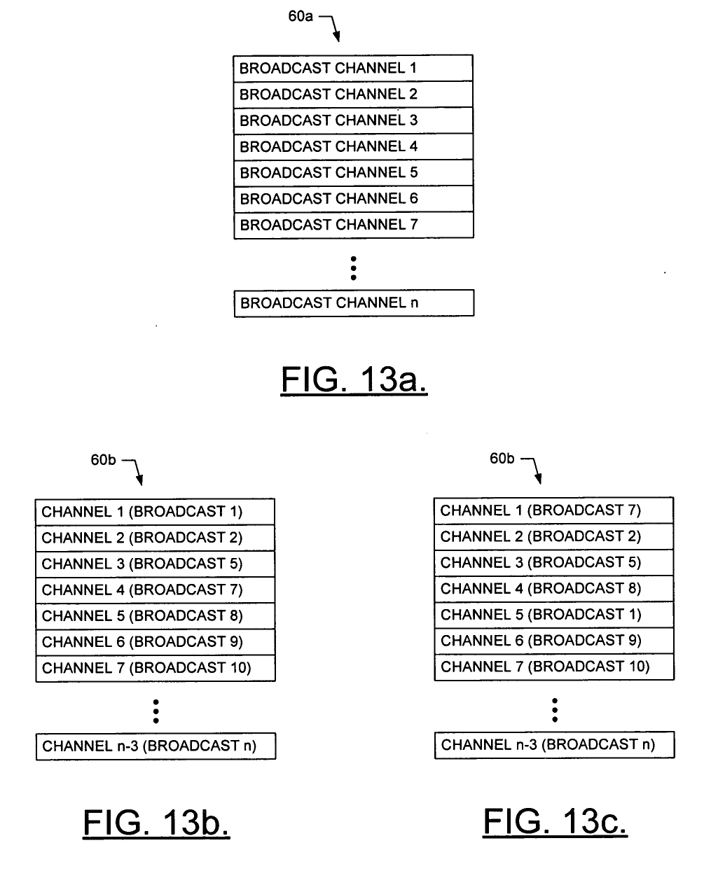

For example, presume that the content source 92 broadcasts a set of ordered channels as shown in the broadcast channel listing 60a FIG. 13a including n ordered channels. Also, presume that the terminal user desires to alter the broadcast channel listing to remove broadcast channels 3, 4 and 6. In such instances, the user-defined set of ordered channels from which the terminal user may select includes n−3 ordered channels, where user-defined channels 1, 2, 3, 4, 5, 6, 7, . . . , n−3 correspond to broadcast channels 1, 2, 5, 7, 8, 9, 10, . . . , n, as shown in the user-defined channel listing 60b of FIG. 13b. Now presume that the terminal user desires to further reorder the user-defined set of channels such that channel 7 is ordered before channel 2, and such that channel 1 is ordered after channel 8. Thus, the user-defined set still includes n−3 ordered channels, but those channels are now ordered such that user-defined channels 1, 2, 3, 4, 5, 6, 7, . . . , n−3 correspond to broadcast channels 7, 2, 5, 8, 1, 9, 10, . . . , n, as shown in the user-defined channel listing of FIG. 13c.

It should also be understood that, as content of one or more channels may be recorded and stored in database 98, the channel(s) of content may be organized in the database in a library of content. The client application 94 can therefore be configured to present, upon request by the terminal user or at a number of other instances, at least a portion of the library. The user can then select one or more pieces of recorded content to thereby direct the client application to consume the selected content from database 117. In addition, the pieces of content may be configured to have associated metadata.

According to one exemplary aspect of the present invention, the functions performed by one or more of the entities of the system, such as the terminal 10, digital broadcaster 14 and/or digital broadcast receiving terminal 18, may be performed by various means, such as hardware and/or firmware, including those described above, alone and/or under control of a computer program product (e.g., client application 94, etc.). The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 8a, 8b and 8c, and 9, are functional block diagrams and flowcharts, respectively, of systems, methods and program products according to exemplary embodiments of the present invention. It will be understood that each block or step of the functional block diagrams and flowcharts, and combinations of blocks in the functional block diagrams and flowcharts, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the functional block diagrams and flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the functional block diagrams and flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the functional block diagrams and flowcharts.

Accordingly, blocks or steps of the flowcharts support combinations of means for performing the specified functions, combinations of steps for performing the specified functions and program instruction means for performing the specified functions. It will also be understood that one or more blocks or steps of the functional block diagrams and flowcharts, and combinations of blocks or steps in the functional block diagrams and flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A mobile terminal for performing at least one operation with respect to broadcast content comprising:
a database capable of storing content; and
a controller capable of operating a client application, wherein the client application is capable of performing at least one operation with respect to a selected channel of a set of channels of broadcast content, wherein the at least one operation includes at least one of operating in a recording mode with respect to currently broadcast content for the selected channel, operating in a recording mode with respect to scheduled content for the selected channel, and operating in an alert mode with respect to scheduled content for the selected channel,
wherein when operating in the recording mode, the client application is capable of recording the content for the selected channel and storing the recorded content in the database, and
wherein when operating in the recording mode, and in response to changing channels from the selected channel to another channel in the set of channels, the client application is capable of initiating a recording timeout for the selected channel, and ceasing recordation of content for the selected channel if the recording timeout expires.

2. A mobile terminal according to claim 1, wherein the client application is capable of resetting the recording timeout for the selected channel for each subsequent instance of changing channels back to the selected channel, and wherein the client application is capable of ceasing recordation of content for the selected channel if the recording timeout expires before being reset for a subsequent instance of changing channels back to the selected channel.

3. A mobile terminal according to claim 1, wherein the client application is capable of recording content for the selected channel such that, if the channel is changed from another channel back to the selected channel, the client application is further capable of consuming the recorded content for the selected channel, and thereafter receiving and consuming content for the selected channel.

4. A mobile terminal according to claim 1 further comprising a buffer memory capable of storing content,
wherein the client application is capable of changing channels from a selected channel x to an adjacent channel x±1 in the set of channels, the channel being changed in a given direction from the selected channel x,
wherein the client application is capable of receiving and consuming content for the adjacent channel x±1 in response to changing channels to the adjacent channel x±1, and
wherein the client application is further capable of receiving and storing content for Y next adjacent channels (x±1)±y, y=1, . . . , Y in buffer memory as content for the adjacent channel is received and consumed, content for the at least one next adjacent channel being received and stored based upon the direction in which the channel is changed and in response to changing channels to the adjacent channel.

5. A mobile terminal according to claim 4, wherein the client application is capable of receiving and storing content for the next adjacent channels (x±1)±y such that, if the channel is changed from the adjacent channel x±1 to the next adjacent channel (x±1)±y, the client application is further capable of consuming the stored content for the next adjacent channel, and thereafter receiving and consuming content for the next adjacent channel.

6. A mobile terminal according to claim 4, wherein the client application is capable of receiving and consuming content for the selected channel x, changing channels from the selected channel x to the adjacent channel x±1, receiving and consuming content for the adjacent channel x±1, and receiving and storing content for the next adjacent channels (x±1)±y at at least one instance, and wherein the adjacent channel x±1 of one instance becomes the selected channel x for a next instance such that x=x±1 from one instance to the next.

7. A mobile terminal according to claim 6, wherein the client application is further capable of initiating a buffer timeout after changing channels from the selected channel x to the adjacent channel x±1, wherein initiating the buffer timeout includes resetting the buffer timeout for each subsequent instance of changing channels, and
wherein the client application is capable of ceasing receipt and storage of content for Y next adjacent channels (x±1)±y, y=1, . . . , Y in buffer memory if the buffer timeout expires before being reset for a subsequent instance of changing channels.

8. A mobile terminal according to claim 7, wherein the client application is further capable of clearing the buffer memory if the buffer timeout expires before being reset for a subsequent instance of changing channels.

9. A mobile terminal according to claim 1 further comprising:
a display capable of being directed by the client application to present a plurality of selectable options to a terminal user, the selectable options including operating in a recording mode with respect to currently broadcast content for the selected channel, operating in a recording mode with respect to scheduled content for the selected channel, and operating in an alert mode with respect to scheduled content for the selected channel, and
wherein the client application is capable of performing the at least one operation in response to selection thereof by the terminal user based upon the presented options.

10. A method of performing at least one operation with respect to broadcast content, the method comprising performing, at a mobile terminal, at least one operation with respect to a selected channel of a set of channels of broadcast content, wherein the at least one operation includes at least one of operating in a recording mode with respect to currently broadcast content for the selected channel, operating in a recording mode with respect to scheduled content for the selected channel, and operating in an alert mode with respect to scheduled content for the selected channel, and wherein operating in the recording mode comprises:
recording the content for the selected channel and storing the recorded content in a database; and
initiating a recording timeout for the selected channel in response to changing channels from the selected channel to another channel in the set of channels,
wherein recording content for the selected channel includes ceasing recordation of content for the selected channel if the recording timeout expires.

11. A method according to claim 10, wherein operating in the recording mode further comprises:
resetting the recording timeout for the selected channel for each subsequent instance of changing channels back to the selected channel,
wherein recording content for the selected channel includes ceasing recordation of content for the selected channel if the recording timeout expires before being reset for a subsequent instance of changing channels back to the selected channel.

12. A method according to claim 10, wherein the recording step comprises recording content for the selected channel such that, if the channel is changed from another channel back to the selected channel, the method further comprises consuming the recorded content for the selected channel, and thereafter receiving and consuming content for the selected channel.

13. A method according to claim 10 further comprising:
changing channels from a selected channel x to an adjacent channel x±1 in the set of channels, the channel being changed in a given direction from the selected channel x;
receiving and consuming content for the adjacent channel x±1 in response to changing channels to the adjacent channel x±1; and
receiving and storing content for Y next adjacent channels (x±1)±y, y=1, . . . , Y in buffer memory as content for the adjacent channel is received and consumed, content for the at least one next adjacent channel being received and stored based upon the direction in which the channel is changed and in response to changing channels to the adjacent channel.

14. A method according to claim 13, wherein the receiving and storing step comprises receiving and storing content for the next adjacent channels (x±1)±y such that, if the channel is changed from the adjacent channel x±1 to the next adjacent channel (x±1)±y, the method further comprises consuming the stored content for the next adjacent channel, and thereafter receiving and consuming content for the next adjacent channel.

15. A method according to claim 13, wherein the receiving and consuming content for the selected channel x, changing channels, receiving and consuming content for the adjacent channel x±1, and receiving and storing content for the next adjacent channels (x±1)±y steps occur at at least one instance, and wherein the adjacent channel x±1 of one instance becomes the selected channel x for a next instance such that x=x±1 from one instance to the next.

16. A method according to claim 15 further comprising:
initiating a buffer timeout after changing channels from the selected channel x to the adjacent channel x±1, wherein initiating the buffer timeout includes resetting the buffer timeout for each subsequent instance of changing channels,
wherein the receiving and storing step further includes ceasing receipt and storage of content for Y next adjacent channels (x±1)±y, y=1, . . . , Y in buffer memory if the buffer timeout expires before being reset for a subsequent instance of changing channels.

17. A method according to claim 16 further comprising clearing the buffer memory if the buffer timeout expires before being reset for a subsequent instance of changing channels.

18. A method according to claim 10 further comprising:
presenting, on a display of the mobile terminal, a plurality of selectable options to a terminal user, the selectable options including operating in a recording mode with respect to currently broadcast content for the selected channel, operating in a recording mode with respect to scheduled content for the selected channel, and operating in an alert mode with respect to scheduled content for the selected channel,
wherein the performing at least one operation step comprises performing at least one operation in response to selection thereof by the terminal user based upon the presented options.

19. A computer program product for performing at least one operation with respect to broadcast content, the computer program product comprising a computer-readable storage medium having computer-readable program code portions stored therein, the computer-readable program code portions comprising:
a first executable portion for performing, at a mobile terminal, at least one operation with respect to a selected channel of a set of channels of broadcast content, wherein the at least one operation includes at least one of operating in a recording mode with respect to currently broadcast content for the selected channel, operating in a recording mode with respect to scheduled content for the selected channel, and operating in an alert mode with respect to scheduled content for the selected channel,
wherein when operating in the recording mode, the first executable portion is adapted to record content for the selected channel and store the recorded content in a database, and adapted to initiate a recording timeout for the selected channel in response to changing channels from the selected channel to another channel in the set of channels, and wherein the first executable portion is adapted to cease recordation of content for the selected channel if the recording timeout expires.

20. A computer program product according to claim 19, wherein when operating in the recording mode the first executable portion is further adapted to reset the recording timeout for the selected channel for each subsequent instance of changing channels back to the selected channel,
wherein the first executable portion is adapted to cease recordation of content for the selected channel if the recording timeout expires before being reset for a subsequent instance of changing channels back to the selected channel.

21. A computer program product according to claim 19, wherein the first executable portion is adapted to consume the recorded content for the selected channel, and thereafter receive and consume content for the selected channel, if the first executable portion changes channels from another channel back to the selected channel.

22. A computer program product according to claim 19 further comprising:
a second executable portion for changing channels from a selected channel x to an adjacent channel x±1 in the set of channels, the channel being changed in a given direction from the selected channel x;
a third executable portion for receiving and consuming content for the adjacent channel x±1 in response to changing channels to the adjacent channel x±1; and
a fourth executable portion for receiving and storing content for Y next adjacent channels (x±1)±y, y=1, . . . , Y in buffer memory as content for the adjacent channel is received and consumed, content for the at least one next adjacent channel being received and stored based upon the direction in which the channel is changed and in response to changing channels to the adjacent channel.

23. A computer program product according to claim 22, wherein the third executable portion is adapted to consume the stored content for the next adjacent channel, and thereafter receive and consume content for the next adjacent channel, if the channel is changed from the adjacent channel x±1 to the next adjacent channel (x±1)±y.

24. A computer program product according to claim 22, wherein the second, third and fourth executable portion is adapted to receive and consume content for the selected channel x, change channels, receive and consume content for the adjacent channel x±1, and receive and store content for the next adjacent channels (x±1)±y at at least one instance, and wherein the adjacent channel x±1 of one instance becomes the selected channel x for a next instance such that x=x±1 from one instance to the next.

25. A computer program product according to claim 24 further comprising:
a fifth executable portion for initiating a buffer timeout after changing channels from the selected channel x to the adjacent channel x±1, wherein initiating the buffer timeout includes resetting the buffer timeout for each subsequent instance of changing channels,
wherein the fourth executable portion is adapted to cease receipt and storage of content for Y next adjacent channels (x±1)±y, y=1, . . . , Y in buffer memory if the buffer timeout expires before being reset for a subsequent instance of changing channels.

26. A computer program product according to claim 25 further comprising an sixth executable portion for clearing the buffer memory if the buffer timeout expires before being reset for a subsequent instance of changing channels.

27. A computer program product according to claim 19 further comprising:
a second executable portion for presenting, on a display of the mobile terminal, a plurality of selectable options to a terminal user, the selectable options including operating in a recording mode with respect to currently broadcast content for the selected channel, operating in a recording mode with respect to scheduled content for the selected channel, and operating in an alert mode with respect to scheduled content for the selected channel,
wherein the first executable portion is adapted to perform at least one operation in response to selection thereof by the terminal user based upon the presented options.
